(19) United States
(12) Patent Application Publication
(10) Pub. No.: US 2015/0073083 A1
(43) Pub. Date: Mar. 12, 2015

(54) TREATED INORGANIC, NON-HALOGENATED FLAME RETARDANTS, METHODS FOR TREATING INORGANIC, NON-HALOGENATED FLAME RETARDANTS, AND APYROUS PLASTICS

(71) Applicant: Honeywell International Inc., Morristown, NJ (US)

(72) Inventors: Yue Wen Liu, Shanghai (CN); Megan Mao, Shanghai (CN); Jun Li, Shanghai (CN)

(21) Appl. No.: 14/453,960

(22) Filed: Aug. 7, 2014

Related U.S. Application Data
(60) Provisional application No. 61/876,336, filed on Sep. 11, 2013.

(51) Int. Cl. C08K 3/22; B05D 1/00; B05D 3/02; B05D 3/04; C09K 21/14; B05D 5/00

(52) U.S. Cl. CPC C08K 3/22; C09K 21/14; B05D 5/00; B05D 3/02; B05D 3/0406; B05D 1/00; C08K 2003/2224
USPC 524/436; 252/609; 427/221

(57) ABSTRACT

Treated, inorganic, non-halogenated flame retardants, methods for treating inorganic, non-halogenated flame retardants for better dispersion and improved powder flow performance in plastics, and apyrous plastics formed from such treated, inorganic, non-halogenated flame retardants are provided. In accordance with an exemplary embodiment, a method for treating an inorganic, non-halogenated flame retardant includes providing a wax emulsion, the wax emulsion comprising a polymer wax, an alkali, and water. The wax emulsion is blended with an inorganic, non-halogenated flame retardant for a period of time to form a treated inorganic, non-halogenated flame retardant. The treated inorganic, non-halogenated flame retardant is dried.

### TECHNICAL FIELD

The technical field generally relates to flame retardants, methods for treating such flame retardants, and apyrous plastics, and more particularly relates to treated inorganic, non-halogenated flame retardants, methods for treating inorganic, non-halogenated flame retardants, and apyrous plastics using such treated inorganic, non-halogenated flame retardants.

### BACKGROUND

Many plastics are flammable. As used herein, “plastics” refers to any of a group of synthetic or natural organic materials that may be shaped when soft and then hardened, including many types of resins, resinoids, polymers, cellulose derivatives, casein materials, and proteins. For flammable plastics that are required to be apyrous, such as cable and those used in household products, adding a flame retardant is typically necessary. Organic halogen flame retardants and inorganic non-halogenated (halogen-free) flame retardants are currently used in plastic applications. However, organic halogen flame retardants will release noxious gas and smoke when burned, whereas inorganic non-halogenated flame retardants, such as magnesium hydroxide (Mg(PH)₂), will not. To achieve a high flammable retardant grade, the amount of inorganic non-halogenated flame retardant to be added to a plastic typically needs to be at or above 60% by weight, but too much inorganic non-halogenated flame retardant can impose a negative impact on mechanical properties of the plastic because of poor dispersion of the flame retardant and non-compatibility with the plastic.

Measures have been taken to pretreat inorganic non-halogenated flame retardants with coupling agents to improve the mechanical properties of the plastics and maintain a high flame retardant grade. For example, silane coupling agents, titanate coupling agents, and higher fatty acid coupling agents have been used as pretreatment aids. However, such coupling agents have demonstrated poor powder flow performance of inorganic non-halogenated flame retardants treated with the coupling agents in plastic compounding processes and also have proven to be quite costly.

Accordingly, it is desirable to provide treated inorganic, non-halogenated flame retardants and methods for treating inorganic, non-halogenated flame retardants for better dispersion within plastics, better compatibility with plastics, and improved powder flow performance in plastic compounding processes. It also is desirable to provide apyrous plastics using such treated inorganic, non-halogenated flame retardants. Furthermore, other desirable features and characteristics will become apparent from the subsequent detailed description and the appended claims, taken in conjunction with the accompanying drawings and this background.

### BRIEF SUMMARY

Treated, inorganic, non-halogenated flame retardants, methods for treating inorganic, non-halogenated flame retardants for better dispersion and improved powder flow performance in plastics, and apyrous plastics are provided. In accordance with an exemplary embodiment, a method for treating an inorganic, non-halogenated flame retardant includes providing a wax emulsion, the wax emulsion comprising a polymer wax, an alkali, and water. The wax emulsion is blended with an inorganic, non-halogenated flame retardant for a period of time to form a treated inorganic, non-halogenated flame retardant. The treated inorganic, non-halogenated flame retardant is dried.

In accordance with a further exemplary embodiment, a treated, inorganic, non-halogenated flame retardant includes an inorganic, non-halogenated flame retardant and a coating that coats the flame retardant. The coating comprises a polymer wax with polymer chains having polar groups.

In yet another exemplary embodiment, an apyrous plastic contains a plastic and a treated, inorganic, non-halogenated flame retardant dispersed throughout the plastic. The treated, inorganic, non-halogenated flame retardant includes an inorganic, non-halogenated flame retardant and a coating that coats the inorganic, non-halogenated flame retardant. The coating contains a polymer wax with polymer chains having polar groups.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

Various embodiments of treated, inorganic, non-halogenated flame retardants, methods for treating inorganic, non-halogenated flame retardants, and apyrous plastics are provided herein. The inorganic, non-halogenated flame retardants are treated with polymer wax emulsions. As used herein, “inorganic, non-halogenated flame retardants” include agents that are used to reduce the ability of plastics, as defined above, to ignite and/or burn. The flame retardants do not contain carbon or halogen atoms or contain carbon and/or halogen atoms in an amount that is not sufficient to change the physical and/or chemical properties of the flame retardant such that they are measurably different, either with or without instrumentation, from a flame retardant without carbon or halogen atoms. Examples of inorganic, non-halogenated flame retardants include, but are not limited to, magnesium hydroxide (Mg(OH)₂), aluminum hydroxide (Al(OH)₃), and mixtures thereof. The polymer wax emulsions comprise a polymer wax, an optional surfactant, and an alkali in water. The polymer wax molecule has both polar and nonpolar groups and forms polar bonds with the inorganic, non-halogenated flame retardants. It has been found that, in a cost effective manner, the dispersibility and the powder flow performance of the inorganic, non-halogenated flame retardants in plastics were improved by treatment of the flame retardants with the wax emulsions.

In an exemplary embodiment, the wax emulsion contains any polymer waxes or mixture of polymer waxes that are capable of forming a dispersion in water and that have polymer chains with polar groups. As used herein, a “polymer wax” is defined as a wax having the same or different monomers and having a number average molecular weight (Mn) in the range of from about 500 to about 20,000 Daltons, for example, 1000 to 8000. Examples of suitable polymer waxes include, but are not limited to, ethylene acrylic acid copolymer waxes (EAA waxes), maleated polyethylene waxes (MAPE waxes), oxidized polyethylene waxes, maleic anhydride grafted polypropylene waxes (MAPP waxes), and oxidized ethylene vinyl acetate waxes (oxidized EVA waxes). The polymer wax is present in the wax emulsion in an amount of about 10 to about 50 weight percent (wt. %) of the total weight of the wax emulsion.

The wax emulsion further includes an optional surfactant or an optional mixture of surfactants. The surfactant serves as an emulsifier. Smaller wax particles can be coated on the flame retardant more homogeneously and, thus, increase the dispersability of the treated flame retardant in the plastic and improve flow properties. The surfactants can be non-ionic, for example, with a hydrophilic-lipophilic balance (HLB) in the range of 3 to 16, anionic, cationic, or an amine-acid soap. Examples of surfactants include, but are not limited to, fatty alcohol ethoxylates and nonylphenol ethoxylates. Suitable commercially-available fatty alcohol ethoxylates include, but are not limited to, Foryl® 2409 (fatty alcohol with 9 moles of ethoxylate moieties), Foryl® 2403 (fatty alcohol with 3 moles of ethoxylate moieties), and Foryl® 2410 (fatty alcohol with 10 moles of ethoxylate moieties), all available from Pulcra Specialty Chemicals Co. Ltd, Shanghai, and OS-15 (fatty alcohol with 15 moles of ethoxylate moieties), available form Shanghai Tiantan Auxiliaries Co., Ltd., Shanghai. Suitable commercially-available nonylphenol ethoxylates include, but are not limited to, Tergitol® NP10 (nonylphenol ethoxylate with 10 moles of ethoxylate moieties) and Tergitol® NP-9 (nonylphenol ethoxylate with 9 moles of ethoxylate moieties), both available from Dow Chemicals, Midland, Mich. Other suitable surfactants include polysorbate 80, polysorbate 60, and triethanolamine. The surfactant is present in the wax emulsion in an amount of about 0 to about 30 wt. % of the total weight of the wax emulsion.

The wax emulsion also contains an alkali. Examples of alkalis that are suitable for use in the wax emulsion contemplated herein include, but are not limited to, potassium hydroxide, sodium hydroxide, triethanolamine, diethanolamine, ammonia, aminomethylpropanol, aminomethyl propanediol, aminoethyl propanediol and the like, and any mixture thereof. Oxidized polymer waxes, such as oxidized PE, EAA, and oxidized EVA, have carboxyl groups (—COOH). These carboxyl groups can be neutralized with the alkali and become carboxylate ions (—COO—). The carboxylate ions are hydrophilic and thus, when the wax emulsion is coupled to the flame retardant, they further facilitate dispersion of the flame retardant within a plastic. The alkali is present in the wax emulsion in an amount of about 0.1 to about 12 wt. % of the total weight of the wax emulsion.

The wax emulsion further comprises water. In an exemplary embodiment, the water, for example, contains deionized water, although other forms of water, for example, tap water or bottled water, could also be used. However, it will be appreciated that the various embodiments are not limited to water and other carriers that can form a stable wax dispersion with the components described above can be used. In an embodiment, the water is present in an amount of about 40 to about 90 wt. % based on the total weight of the wax emulsion.

In accordance with another exemplary embodiment, a method of making a wax emulsion used for treating an inorganic, non-halogenated flame retardant includes adding the above-described components to a pressure vessel. In particular, a wax polymer, an optional surfactant, an alkali, and water are added to a pressure vessel and the vessel is sealed. The mixture is heated to a temperature of about 10° C. to about 20° C. above the melting point of the polymer wax(s) and the temperature is maintained for about 15 to 35 minutes, for example about 20 minutes, with constant stirring. Any suitable form of mixing can be used to combine the ingredients, such as high shear mixing, stirring, agitation, blending, or any combination thereof. Next, the resulting wax emulsion is cooled to room temperature with continuous stirring. The wax emulsion can be cooled by subjecting it to room temperature for a period of time or by cooling it within the pressure vessel that has a coil cooling system. Of course, other methods known in the art can also be used.

An inorganic, non-halogenated flame retardant can be treated with a wax emulsion contemplated herein by a wet process or a blend process. Both processes can be used to treat a synthetically-made inorganic, non-halogenated flame retardant or a natural inorganic, non-halogenated flame retardant. According to an embodiment, a method for treating the inorganic, non-halogenated flame retardant using the wet process includes adding the wax emulsion to a slurry of the inorganic, non-halogenated flame retardant. Such a slurry can be manufactured but also is available upon synthesis of an inorganic, non-halogenated flame retardant. For example, synthesis of Mg(OH)₂ is water-based and, when completed, results in a Mg(OH)₂ slurry, which is typically dried to obtain Mg(OH)₂ powder. However, the wet process of treating Mg(OH)₂ can take advantage of this Mg(OH)₂ slurry by adding the wax emulsion to the Mg(OH)₂ slurry itself.

Whether the wax emulsion is added to an inorganic, non-halogenated flame retardant slurry formed during synthesis of the flame retardant or formed otherwise, the wax emulsion/flame retardant mixture is stirred to obtain a homogeneous mixture. In one embodiment, the mixture is stirred at 20 to 110 rotations per minute (RPM) for about 30 to 60 minutes. In another embodiment, the mixture is stirred at about 50 to about 60° C. The water of the wax emulsion and any water from the inorganic, non-halogenated flame retardant slurry then are removed from the mixture, such as through a pressure screen. Next, the mixture is dried. In an embodiment, the mixture can be dried by heating it in a drying machine at about 90 to about 100° C. Alternatively, the mixture can be dried by exposing it to the atmosphere for a sufficient time for the water to evaporate.

In another embodiment, a method for treating the inorganic, non-halogenated flame retardant using the blend process includes mixing inorganic, non-halogenated flame retardant powder and the wax emulsion in a mixer or blender. The wax emulsion can be added in one amount or can be added in discrete amounts with time in between addition of the amounts for blending. For example, the wax emulsion can be divided into three discrete portions that are added to the flame retardant about ten minutes apart. Once blended, the treated flame retardant is then dried as described above. While the wet process and the blend process are described herein for combining the wax emulsion and the inorganic, non-halogenated flame retardant, the embodiments are not so limited and the flame retardant can also be treated with the wax emulsion by other methods, such as by using fluidized beds. Regardless of the method used for treating, the inorganic, non-halogenated flame retardant is coated with a coating comprising at least the polymer wax and, if present, the surfactant. In an exemplary embodiment, the dry, treated, inorganic, non-halogenated flame retardant has about 2 to about 6 wt. %, for example, about 3 to about 4 wt. %, wax solids, based on the total weight of the dry, treated, inorganic, non-halogenated flame retardant.

A method for fabricating an apyrous plastic using the treated inorganic, non-halogenated flame retardant contemplated herein includes mixing the treated inorganic, non-halogenated flame retardant with a resin. Examples of resins that can be combined with the treated inorganic, non-halogenated flame retardant contemplated herein include, but are not limited to, linear low density polyethylene (LLDPE), ethylene vinyl acetate resins (EVA), and thermoplastic elastomer (TPE). In an exemplary embodiment, the flame retardant and the plastic can be mixed using a twin screw extruder compounding machine, although other methods for mixing the flame retardant and the plastic or plastics can be used.

The following is an example of a wax emulsion for use in treating inorganic, non-halogenated flame retardants to be used in plastics. The example is provided for illustration purposes only and is not meant to limit the various embodiments contemplated herein in any way.

### Example

TREATED INORGANIC, NON-HALOGENATED FLAME RETARDANT 1 (“Flame Retardant 1”): To a pressure vessel, 36.5 wt. % A-C® 540 ethylene-acrylic acid copolymer wax, available from Honeywell International Inc., Morristown, N.J., 0.85 wt. % Foryl 2409, 0.85 wt. % Foryl 2403, 1.49 wt. % triethanolamine, 0.34 wt. % KOH, and 60 wt. % deionized water were added and the pressure vessel was sealed. The mixture was heated to 125° C. for 20 minutes while the mixture was constantly stirred. Next, the mixture was cooled to room temperature using a coil cooling system in the vessel with continuous stirring. The resulting wax emulsion had an approximate 40% solids content.

About 21.9 kg of the 40% solids-content wax emulsion then was added to 500 kg 50% solids-content Mg(OH)₂ slurry in a mixer with a blade rotating at 20-110 rpm at 50-60° C. for 30-60 minutes. The water was removed from the mixture using a pressure screen machine used for removing liquid under pressure. After 10 minutes of pressure, the treated flame retardant was dried in a drying machine for 2-3 hours at 90-100° C.

TREATED INORGANIC, NON-HALOGENATED FLAME RETARDANT 2 (“Flame Retardant 2”): To a pressure vessel, 28 wt. % A-C® 325 oxidized polyethylene homopolymer wax, available from Honeywell International Inc., Morristown, N.J., 7 wt. % Foryl 2409, 1 wt. % KOH, and 64 wt. % deionized water were added and the pressure vessel was sealed. The mixture was heated to 150° C. for 30 minutes while the mixture was constantly stirred. Next, the mixture was cooled to room temperature using a coil cooling system in the vessel with continuous stirring. The resulting wax emulsion had an approximate 35% solids content.

About 0.25 kg of the 35% solids-content wax emulsion then was added to 2 kg untreated Mg(OH)₂ powder in a mixer with an agitator for 30-60 minutes. The treated flame retardant was dried in an oven for 2-3 hours at 90° C.

Next, 60 wt. % of each of the Flame Retardant 1 and the Flame Retardant 2 was mixed with 8 wt. % LLDPE 7042 from Sinopec Group, China, and 32 wt. % Cosmothene® EVA KA-31 from TPC, Pte. Ltd., Singapore, in a mixer. The mixtures then were placed in a hopper of a twin screw extruder. The extruder had a diameter of 36 mm and a length/diameter ratio of 40. The feeder was at 150° C., and the temperature increased along the extruder with the die having a temperature of 210° C. The final compounds were dried in an oven at 100° C. for 4 hours. The flow speed of resin with Flame Retardant 1 (treated Mg(OH)₂ mixed with A-C® 540) was tested at 10 min/3.4 kg and the flow speed of resin with Flame Retardant 2 (treated Mg(OH)₂ mixed with A-C® 325) was tested at 15 min/3.4 kg. These flow performances were significantly better than compared to those of the same resins mixed with MAGNIFIN® H-5IV (magnesium hydroxide treated with an amino polysiloxane) by Albemarle Corporation, Baton Rouge, La., (26 min/3.4 kg), and mixed with untreated magnesium hydroxide (30 min/3.4 kg). Better flow performance indicates a more efficient compounding process.

The following mechanical properties of the resulting plastics (Injected Samples #3 and #4 in the Table below) were determined and compared to the same plastics with MAGNIFIN® H-5IV and with untreated magnesium hydroxide. The tensile strength was measured using the ASTM (D638) standard method that measures the ability of material to resist a force that tends to pull it apart. It is expressed as the minimum tensile stress (force per unit area) needed to split the material apart. The tensile strain is defined as the extension of the material per unit length or strain=extension/original length. The higher the number, the greater the toughness of the material. Notched Izod is an ASTM (D256) standard method of determining the impact resistance of materials. An arm held at a specific height (constant potential energy) is released about a pivot point. The arm hits the sample and breaks it. From the energy absorbed by the sample, its impact energy is determined. A notched sample is generally used to determine impact energy and notch sensitivity. NB means no break. UL 94 is a plastics flammability standard released by Underwriters Laboratories of Northbrook, Ill. The standard classifies plastics according to how they burn in various orientations and thicknesses. From lowest (least flame-retardant) to highest (most flame-retardant), the classifications are: HB: slow burning on a horizontal specimen; burning rate <76 mm/min for thickness <3 mm and burning stops before 100 mm; V2 burning stops within 30 seconds on a vertical specimen; drips of flaming particles are allowed; V1: burning stops within 30 seconds on a vertical specimen; drips of particles allowed as long as they are not inflamed; VO: burning stops within 10 seconds on a vertical specimen; drips of particles allowed as long as they are not inflamed.

| | | Percentage of | | | | | |
|---|---|---|---|---|---|---|---|
| | | Wax Solids in | | | | | |
| Injected | Description of | Total Weight | Tensile | Tensile | | | |
| sample | Mg(OH)2 in | of Treated | strength in | strain in | Notched | | Flow Speed |
| ID | injected sample | Mg(OH)2 | yield (MPa) | break (%) | Izod (J/m) | UL 94 | (min/3.4 kg) |
| 1# | untreated-original | 0 | 12.08 | 46.77 | NB | V0 | 30 |
| | Mg(OH)2 | | | | | | |
| 2# | commercialized | NA | 12.29 | 81.81 | 529.412 | V0 | 26 |
| | product | | | | | | |
| | (MAGNIFIN H- | | | | | | |
| | 5IV) | | | | | | |
| 3# | treated by A-C540 | 3.5% | 10.11 | 72.64 | 537.716 | V0 | 10 |
| | via | | | | | | |
| | wet process | | | | | | |
| 4# | Treated by A-C325 | 3.5% | 9.53 | 75.99 | NB | V0 | 15 |
| | via blending process | | | | | | |

As noted from the above results, while the plastic having a inorganic, non-halogenated flame retardant treated with the wax emulsion contemplated herein has superior flow properties than the plastics with the commercial flame retardant and with the untreated magnesium hydroxide, its mechanical and flame retardant properties maintained sufficiently close to those of the plastics with the commercial flame retardant and, thus, were not adversely affected by the wax emulsion.

TREATED INORGANIC, NON-HALOGENATED FLAME RETARDANT 3 (“Flame Retardant 3”): About 15.625 kg of the 40% solids-content wax emulsion prepared above for Flame Retardant 1 was added to 500 kg of 50% solids-content Mg(OH)₂ slurry in a mixer with a blade rotating at 20-100 rpm at 50-60° C. for 30 to 60 minutes. The water was removed from the mixture using a pressure screen machine used for removing liquid under pressure. After 10 minutes of pressure, the treated flame retardant was dried in a drying machine for 2-3 hours at 90-100° C. While the ratio of A-C540 to Mg(OH)₂ for Flame Retardant 1 was 21.9 kg:250 kg or 8.76%, the ratio of A-C540 to Mg(OH)₂ for Flame Retardant 3 was 15.625 kg:250 kg or 6.25%.

Next, 60 wt. % of each of untreated Mg(OH)₂, Flame Retardant 3, and MAGNIFIN® H-5IV was mixed with 6 wt. % ELITE™ 5220G LLDPE from Dow Chemical Company and 28.3 wt. % ELVAX® 265 EVA and 5 wt. % FUSABOND® E226 MAPE both from DuPont de Nemours of Wilmington, Del. in a mixer. The mixtures then were placed in a hopper of a twin screw extruder. The extruder had a diameter of 36 mm and a length/diameter ratio of 40. The feeder was at 150° C. and the temperature increased along the extruder with the die having a temperature of 210° C. The final compounds were dried in an oven at 100° C. for 4 hours. The flow speed of resin with Flame Retardant 3 (treated Mg(OH)₂ mixed with A-C 540) was tested at 25 min/4.5 kg, the flow speed of resin with MAGNIFIN® H-5IV was tested at 32 min/4.5 kg, and the flow speed of resin with untreated Mg(OH)₂ was tested at 35 min/4.5 kg. Of these three samples, the resin treated with Flame Retardant 3 demonstrated the greatest tensile strain at break (%) and the best flowability.

| Injected | Description of | Tensile | Tensile | |
|---|---|---|---|---|
| sample | Mg(OH)₂ in | strength | strain in | Flow Speed |
| ID | injected sample | in yield (MPa) | break (%) | (min/4.5 kg) |
| #1 | untreated-original | 15.6 | 104 | 35 |
| | Mg(OH)₂ | | | |
| #2 | Flame Retardant 3 | 13.4 | 172 | 25 |
| #3 | MAGNIFIN ® H- | 15.8 | 131 | 32 |
| | 5IV | | | |

Accordingly, various embodiments of treated, inorganic, non-halogenated flame retardants, methods for treating inorganic, non-halogenated flame retardant, and apyrous plastics using such treated, inorganic, non-halogenated flame retardants have been described. The treated, inorganic, non-halogenated flame retardants, in a cost effective manner, display increased dispersability in resins and improved powder flow performance without adverse mechanical properties of the plastics.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for treating an inorganic, non-halogenated flame retardant, the method comprising the steps of:
providing a wax emulsion, the wax emulsion comprising a polymer wax, an alkali, and water;
blending the wax emulsion and the inorganic, non-halogenated flame retardant for a period of time to form a treated inorganic, non-halogenated flame retardant; and
drying the treated inorganic, non-halogenated flame retardant to form a dry treated inorganic, non-halogenated flame retardant.

2. The method of claim 1, wherein the dry treated inorganic, non-halogenated flame retardant has about 2 to about 6 wt. % wax solids based on a total weight of the dry treated inorganic, non-halogenated flame retardant.

3. The method of claim 2, wherein the dry treated inorganic, non-halogenated flame retardant has about 3 to about 4 wt. % wax solids based on the total weight of the dry treated inorganic, non-halogenated flame retardant.

4. The method of claim 1, wherein the polymer wax comprises ethylene acrylic acid copolymer waxes (EAA waxes), maleated polyethylene waxes (MAPE waxes), oxidized polyethylene waxes, maleic anhydride grafted polypropylene waxes (MAPP waxes), oxidized ethylene vinyl acetate waxes (oxidized EVA waxes), or any mixture thereof.

5. The method of claim 1, wherein the polymer wax is present in the wax emulsion in an amount of about 10 to about 50 wt. % of a total weight of the wax emulsion.

6. The method of claim 1, wherein the wax emulsion further comprises a surfactant present in the wax emulsion in an amount of from about 0 to about 30 wt. % based on a total weight of the wax emulsion.

7. The method of claim 6, wherein the surfactant comprises a nonionic surfactant, an anionic surfactant, a cationic surfactant, an amine-acid soap, or any mixture thereof.

8. The method of claim 1, wherein the alkali comprises potassium hydroxide, sodium hydroxide, triethanolamine, diethanolamine, ammonia, aminomethyl propanol, aminomethyl propanediol, aminoethyl propanediol, and any mixture thereof.

9. The method of claim 1, wherein the alkali is present in the wax emulsion in an amount of about 0.1 to about 12 wt. % based on a total weight of the wax emulsion.

10. The method of claim 1, wherein the water is present in the wax emulsion in an amount of about 40 to about 90 wt. % based on a total weight of the wax emulsion.

11. The method of claim 1, wherein the polymer wax comprises ethylene-acrylic acid copolymer, the alkali comprises KOH, the water comprises deionized water, and the wax emulsion further comprises a surfactant mixture of a nonionic surfactant with 9 ethoxylate moieties, a nonionic surfactant with 3 ethoxylate moieties, and triethanolamine.

12. The method of claim 1, wherein the inorganic, non-halogenated flame retardant comprises magnesium hydroxide (Mg(OH)₂), aluminum hydroxide (Al(OH)₃), or a combinations thereof.

13. The method of claim 1, wherein the inorganic, non-halogenated flame retardant is in a form of a slurry and wherein the blending step comprises:
blending the wax emulsion with the slurry to obtain a homogeneous mixture;
removing water from the homogeneous mixture to form the treated inorganic, non-halogenated flame retardant.

14. A treated, inorganic, non-halogenated flame retardant comprising:
an inorganic, non-halogenated flame retardant; and
a coating that coats the inorganic, non-halogenated flame retardant, wherein the coating comprises a polymer wax with polymer chains having polar groups.

15. The treated, inorganic, non-halogenated flame retardant of claim 14, wherein the inorganic, non-halogenated flame retardant comprises magnesium hydroxide (Mg(OH)₂), aluminum hydroxide (Al(OH)₃), or a combinations thereof.

16. The treated, inorganic, non-halogenated flame retardant of claim 14, wherein the polymer wax comprises ethylene acrylic acid copolymer (EAA), maleated polyethylene (MAPE), oxidized polyethylene, maleic anhydride grafted polypropylene (MAPP), oxidized ethylene vinyl acetate (oxidized EVA), or any mixture thereof.

17. The treated, inorganic, non-halogenated flame retardant of claim 14, wherein the coating further comprises a surfactant.

18. The treated, inorganic, non-halogenated flame retardant of claim 17, wherein the surfactant comprises a fatty alcohol ethoxylate, a nonylphenol ethoxylate, a polysorbate 80, a polysorbate 60, a triethanolamine, or any mixture thereof.

19. The treated, inorganic, non-halogenated flame retardant of claim 14, wherein the treated, inorganic, non-halogenated flame retardant has about 2 to about 6 wt. % wax solids based on a total weight of the treated, inorganic, non-halogenated flame retardant.

20. An apyrous plastic comprising:
a plastic; and
a treated, inorganic, non-halogenated flame retardant dispersed throughout the plastic, the treated, inorganic, non-halogenated flame retardant comprising:
an inorganic, non-halogenated flame retardant; and
a coating that coats the inorganic, non-halogenated flame retardant, wherein the coating comprises a polymer wax with polymer chains having polar groups.
